(19) United States
(12) Patent Application Publication
(10) Pub. No.: US 2016/0234436 A1
(43) Pub. Date: Aug. 11, 2016

(54) Birds-Eye-View Monitoring System With Auto Alignment

(71) Applicant: Delphi Technologies, Inc., Troy, MI (US)

(72) Inventors: Mengmeng Yu, Shanghai (CN); Guanglin Ma, Shanghai (CN); Ruyi Jiang, Shanghai (CN)

(21) Appl. No.: 14/972,909

(22) Filed: Dec. 17, 2015

(30) Foreign Application Priority Data
Feb. 6, 2015 (CN) 201510064891.1

(51) Int. Cl. H04N 5/232; H04N 5/247; G06T 7/00; H04N 7/18

(52) U.S. Cl. CPC H04N 5/23238; H04N 7/181; H04N 5/247; G06T 7/0018

(57) ABSTRACT

A surround view monitoring system configured to synthesize a birds-eye-view image of an area around a vehicle includes a camera and a controller. The camera is configured to capture a present-image of a field-of-view about the vehicle and output a signal indicative of the present-image. The present-image includes a feature of the vehicle. The controller is configured to receive the signal, compare the present-image to a reference-image from an initial calibration of the system. The reference-image also includes the feature. The controller is further configured to determine a correction table for the present-image to align the feature in the present-image to the feature in the reference-image.

### TECHNICAL FIELD OF INVENTION

This disclosure generally relates to a system configured to synthesize a birds-eye-view image of an area around a vehicle, and more particularly relates to way to align multiple cameras using a feature of the vehicle present in an image from a camera as an alignment guide to align the cameras of the system.

### BACKGROUND OF INVENTION

Surround view monitoring or birds-eye-view image systems configured to synthesize a birds-eye-view image of an area around a vehicle are known. Such systems typically have a plurality of cameras, and the images from each of these cameras are combined or ‘stitched’ together to form or synthesize the birds-eye-view image. In order to form a birds-eye-view image without objectionable discontinuities in the birds-eye-view image, each of the cameras needs to be physically aligned, and/or the images from each camera need to be electronically aligned. The alignment process may include a factory alignment of the cameras prior to installation, and/or may include an initial calibration of the system when the system is first installed on a vehicle. This initial calibration may employ an arrangement of known visual targets to assist with the initial calibration.

During the life of the system one or more of the cameras may need to be replaced because of, for example, inadvertent damage to a camera. The replacement may introduce misalignment of the cameras leading to undesirable discontinuities in the birds-eye-view image. Furthermore, vehicle vibration and/or exposure to temperature extremes may introduce undesirable misalignment of the cameras. Having to employ a qualified technician to realign the cameras is inconvenient and expensive for the owner of the vehicle, and such re-alignment may not be effective to correct a problem if the misalignment occurs only at temperature extremes. What is needed is a way for the system to automatically check the alignment of the images from the cameras on a periodic basis.

### SUMMARY OF THE INVENTION

In accordance with one embodiment, a surround view monitoring system configured to synthesize a birds-eye-view image of an area around a vehicle is provided. The system includes a camera and a controller. The camera is configured to capture a present-image of a field-of-view about the vehicle and output a signal indicative of the present-image. The present-image includes a feature of the vehicle. The controller is configured to receive the signal, compare the present-image to a reference-image from an initial calibration of the system. The reference-image also includes the feature. The controller is further configured to determine a correction table for the present-image to align the feature in the present-image to the feature in the reference-image.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a top view of a surround view monitoring system installed on a vehicle in accordance with one embodiment;

FIG. 2 is a schematic diagram of the system of FIG. 1 in accordance with one embodiment;

FIG. 3 is a birds-eye-view image provided by the system of FIG. 1 when the cameras of the system are aligned in accordance with one embodiment;

FIG. 4 is a birds-eye-view image provided by the system of FIG. 1 when the cameras of the system are not aligned in accordance with one embodiment;

FIG. 5A is a present-image from a camera of the system of FIG. 1 in accordance with one embodiment;

FIG. 5B is a reference-image from a camera of the system of FIG. 1 in accordance with one embodiment;

FIG. 6A is a representation of a feature of the vehicle in the image of FIG. 5A in accordance with one embodiment;

FIG. 6B is a representation of a feature of the vehicle in the image of FIG. 5B in accordance with one embodiment; and

FIG. 6C is a representation of an overlay of FIGS. 6A and 6B in accordance with one embodiment.

### DETAILED DESCRIPTION

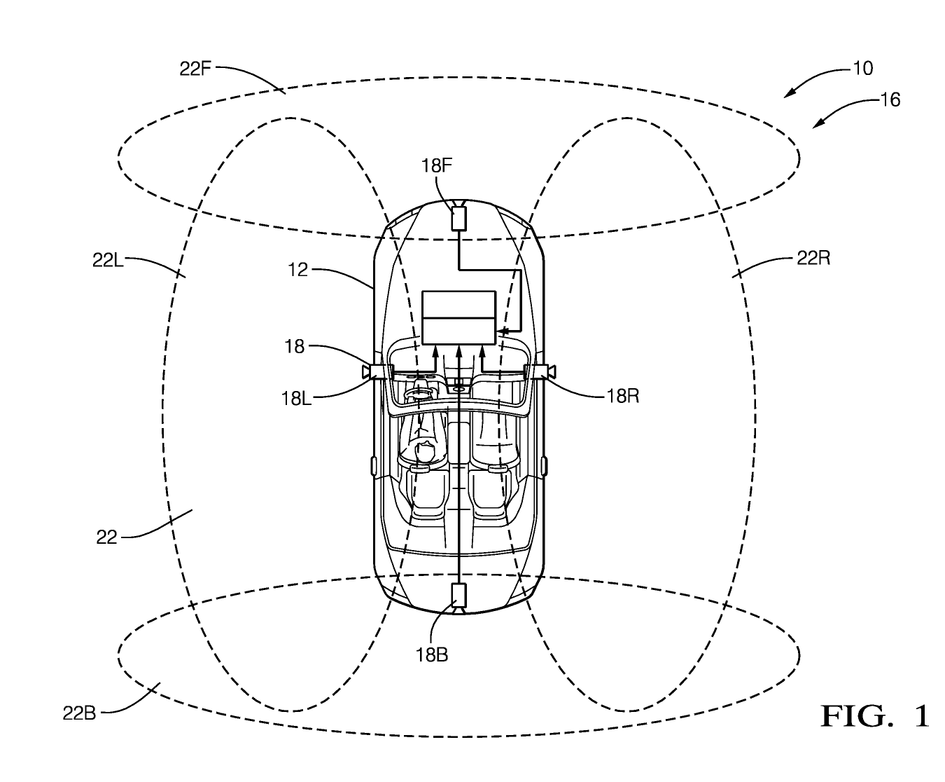

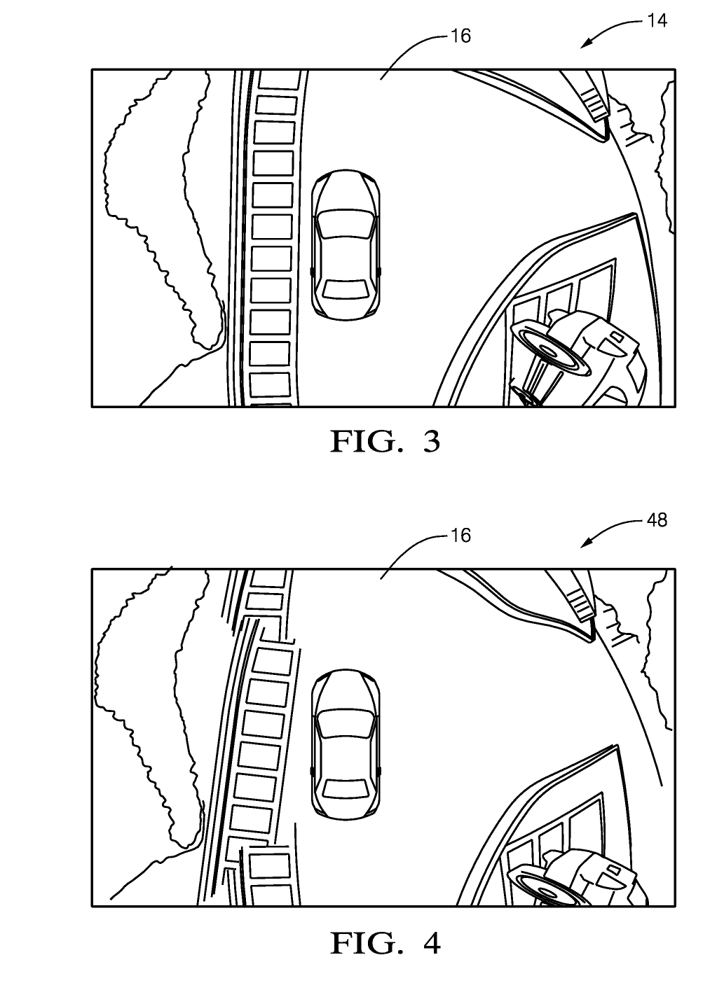

FIG. 1 illustrates a non-limiting example of a surround view monitoring system, hereafter referred to as the system 10, installed on a vehicle 12. In general, the system 10 is configured to synthesize a birds-eye-view image 14 (FIG. 3) of an area 16 around the vehicle 12. As will become apparent in the description that follows, the system 10 described herein captures images from a plurality of cameras mounted to have different fields of view about the vehicle 12, and electronically combines or ‘stitches together’ these images to form or synthesize the birds-eye-view image 14. An advantage of the system 10 described herein is that the alignment of the plurality of images is automated. The alignment is necessary so the birds-eye-view image 14 does not have objectionable discontinuities. Advantageously, the vehicle 12 does not need to be brought to a technician for camera alignment if one or more of the cameras becomes misaligned.

The system 10 includes a camera 18. By way of example and not limitation, the camera 18 may be a left-view-camera 18L, a right-view-camera 18R, a front-view-camera 18F, and/or a back-view-camera 18B. The non-limiting example of the system 10 described herein shows four cameras, but systems with more or less than four cameras are contemplated. In this instance four cameras are shown as this seems to be a good balance between cost and performance, where costs may undesirably increase if more than four cameras are used, and performance (i.e. quality of the birds-eye-view image 14) may undesirably decrease if fewer than four cameras are used. As used herein, the camera 18 may refer to any one and/or all of the cameras shown. As will become apparent in the description that follows, the focus of the non-limiting examples provided herein is generally directed to the left-view-camera 18L. However, references to the camera 18 are not to be construed as being limited to the left-view-camera 18L.

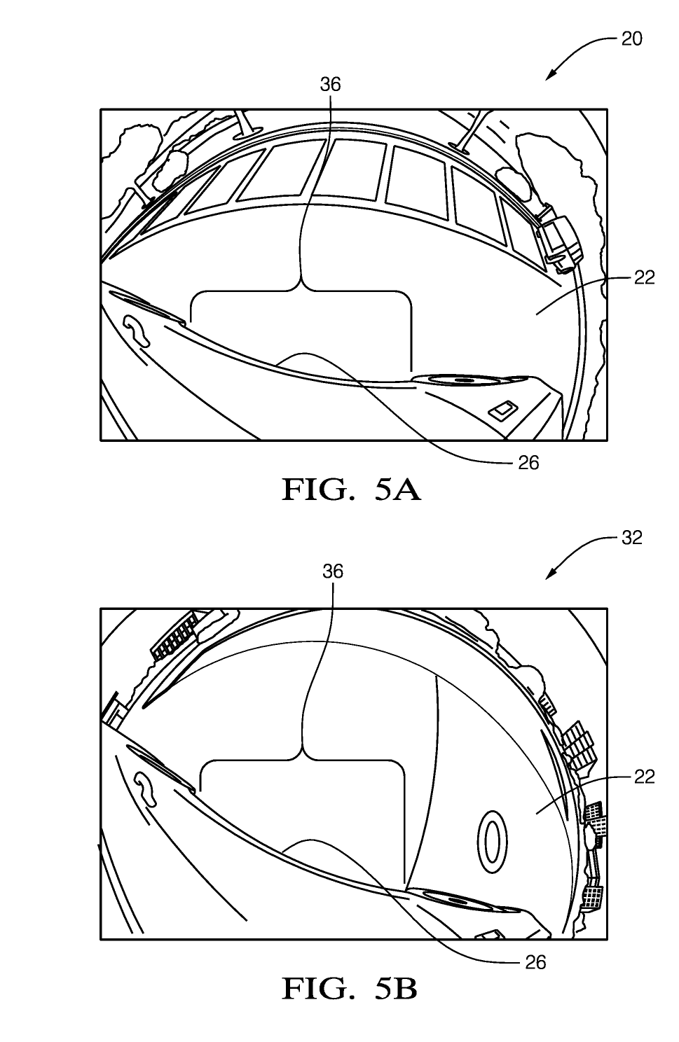

The camera 18 is configured to capture a present-image 20 (FIG. 5A) of a field-of-view 22 about the vehicle 12. As non-limiting example of the system 10 described herein has four cameras, the field-of-view 22 may include a left-field 22L, a right-field 22R, a front-field 22F, and a back-field 22B. As the camera 18, the field-of-view 22 may refer to any one and/or all of the views shown. As will become apparent in the description that follows, the focus of the non-limiting examples provided herein is generally directed to the left-field 22L. However, references to the field-of-view 22 are not to be construed as being limited to the left-field 22L. In general, the combination of the left-field 22L, the right-field 22R, the front-field 22F, and the back-field 22B cover or make up the area 16.

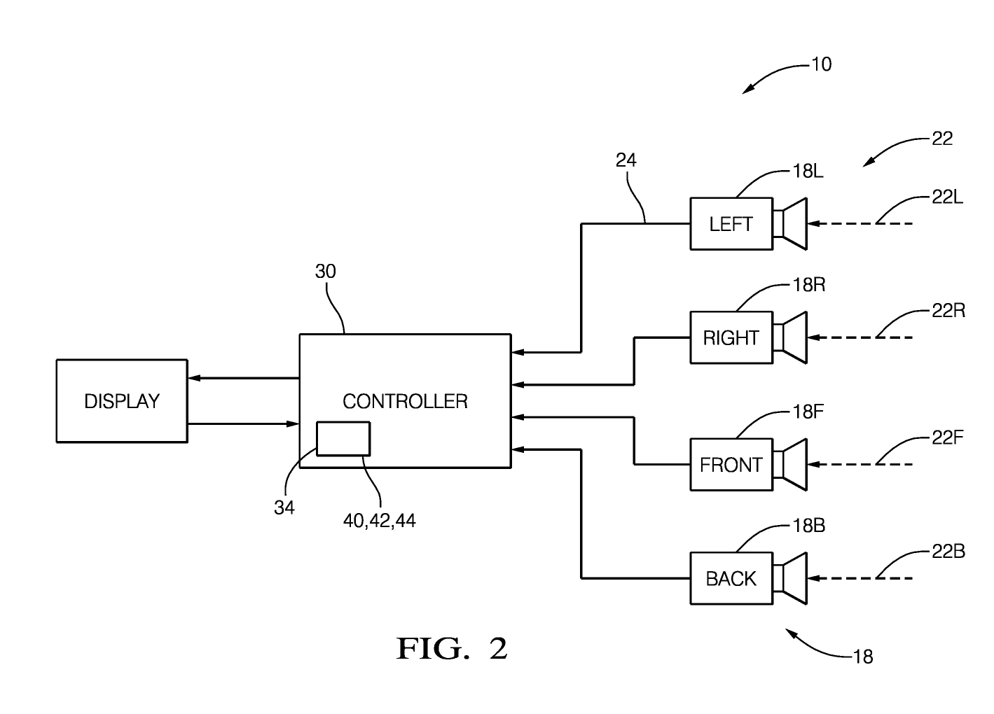

FIG. 2 further illustrates non-limiting details of the system 10. The camera 18 is generally configured to output a signal 24 indicative of the present-image 20 (FIG. 5A). The field-of-view 22 may include a portion of the vehicle 12, so the present-image 20 may include an image of a feature 26 (FIG. 5A) of the vehicle 12 such as a boundary or edge of the body of the vehicle 12.

Continuing to refer to FIG. 2, the system 10 may include a controller 30 configured to receive the signal 24. The controller 30 may include a processor (not shown) such as a microprocessor or other control circuitry such as analog and/or digital control circuitry including an application specific integrated circuit (ASIC) for processing data as should be evident to those in the art. The controller 30 may include memory (not shown), including non-volatile memory, such as electrically erasable programmable read-only memory (EEPROM) for storing one or more routines, thresholds and captured data. The one or more routines may be executed by the processor to perform steps for determining if the images from the various cameras described herein are aligned.

In particular, the controller 30 is configured to compare the present-image 20 (FIG. 5A) to a reference-image 32 from an initial calibration of the system 10. As used herein, the term ‘initial calibration’ is used to refer to a calibration process performed after the system 10 is installed on the vehicle so that the location of the feature 26 in the reference-image 32 can be stored for future use to align the camera 18, if necessary. As such, the initial calibration of the system 10 is distinguished from a factory calibration of the system 10 prior to installation onto the vehicle, and is distinguished from any calibration process that relies on placing a geometric pattern or known targets around the vehicle 12 to assist with alignment of the cameras. As the present-image 20 and the reference-image 32 both include the feature 26, the location of the feature 26 in the respective images can be used to determine a correction table 34 (FIG. 2) for the present-image 20 indicated by the signal 24 to align the feature 26 in the present-image 20 to the feature 26 in the reference-image 32, which is typically stored in the controller 30.

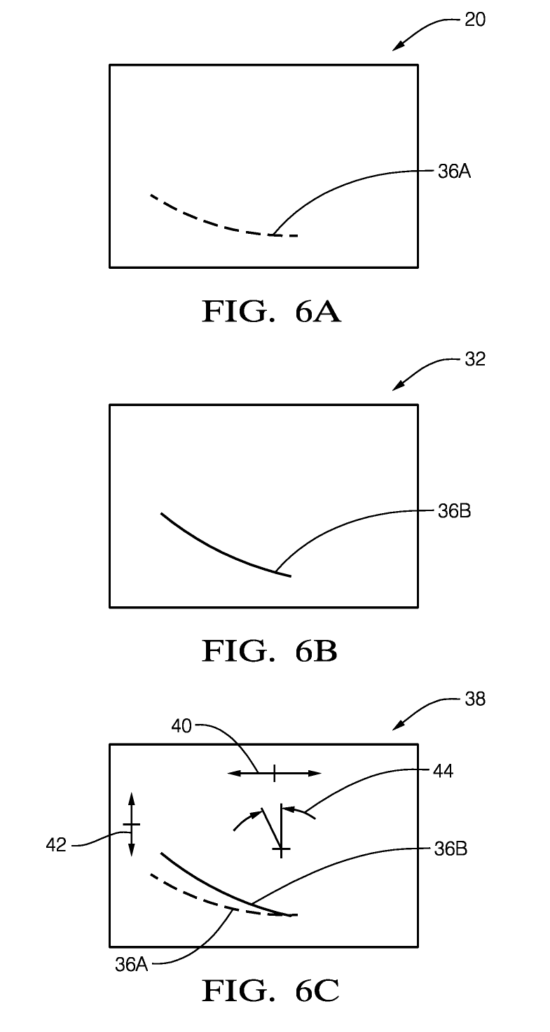

FIGS. 6A and 6B illustrate non-limiting examples of image processed versions of the present-image 20 and the reference-image 32 that correspond to the images shown in FIGS. 5A and 5B, respectively, where an edge 36 of the vehicle 12 is defined in each image. The processing of the images uses known algorithms to determine the location in the present-image 20 of a present-edge 36A of the vehicle 12, and the location in the reference-image 32 of a reference-edge 36B. It is noted that illustration in FIG. 6A of the present-edge 36A is dashed only for the purpose of distinguishing it from the reference-edge 36B when both are illustrated in a combined-image 38 (FIG. 6C).

FIG. 6C further illustrates various directional adjustments or directional corrections that can be stored in the correction table 34 and applied to the present-image 20 in order to align the present-image 20 with the reference-image 32. The correction table may include, but is not limited to, a pan angle 40 for making left/right direction adjustments, a yaw angle 42 for making up/down direction adjustments, and a roll angle 44 for making clockwise/counter-clockwise adjustments. When these adjustments are applied to the signal 24 which indicates the present-image 20, the present-edge 36A can be moved to overlay the reference edge so that the camera 18, in this example the left-view-camera 18L, is properly aligned with the other cameras, for example the right-view-camera 18R, the front-view-camera 18F, and the back-view-camera 18B.

FIG. 4 illustrates a non-limiting example of a misaligned-view 48 where the camera 18 (e.g. the left-view-camera 18L) is not properly aligned. FIG. 4 corresponds to the birds-eye-view-image that would be provided if the present-image 20 shown in FIG. 5A was not corrected or aligned. FIG. 3 show an example of the birds-eye-view-image that would be provided after the present-image 20 shown in FIG. 5A is aligned so the edge 36 in the present-image 20, i.e. the present-edge 36A, is corrected or aligned with the reference-edge 36B in the reference-image 32.

As the camera 18 may become misaligned at any time due to vibration or temperature extremes, it may be advantageous if the controller 30 is configured to align the present-image on a periodic basis, once per minute for example. A periodic alignment may be particularly useful when the system 10 is properly aligned at, for example, cold temperatures (e.g. <0° C.), but becomes misaligned at elevated temperatures (e.g. <30° C.)

The area 16 may include a surface (e.g. the ground) underlying the vehicle 12 with a color and/or illumination that makes it difficult to distinguish the ground from the body of the vehicle 12. As such, it may be advantageous if the controller 30 is configured to perform the initial calibration and/or the alignment process only when the vehicle 12 is moving, for example at a speed greater than thirty kilometers-per-hour (30 kph). It is expected that when the vehicle 12 is moving at a sufficient speed, the portion of the field-of-view 22 that is the roadway underneath the vehicle 12 will vary in appearance. As such, as will be recognized by those in the image processing arts, the unchanging portion of the field-of-view 22 that is the vehicle 12 will be easier to distinguish from the roadway.

It may also be advantageous if the controller 30 is configured to perform the initial calibration and/or the alignment process only when an ambient light intensity is greater than an illumination threshold. By way of example, the illumination threshold may correspond to noon on a cloudy day. If this illumination threshold is used, then alignment will not be performed at night when artificial illumination from street lights, for example, may make it difficult for the controller 30 to determine the location of the edge 36.

Accordingly, a surround view monitoring system (the system 10) configured to synthesize a birds-eye-view image 14 of an area around a vehicle 12 is provided. The system 10 advantageously makes use of features of the vehicle 12 in captured images to adjust the alignment of the cameras of the system. The adjustment or alignment is made based on a comparison of the locations of a particular feature in a present-image 20 captured at about the time when the adjustment is being made to a reference image captured at about the time when the system 10 was initially installed on the vehicle 12. Such an alignment scheme is advantageous as it can be performed in the background, so the vehicle owner does not need to employ a skilled technician to align the system if misalignment occurs. Furthermore, the system can compensate for variations in alignment due to changes in temperature.

While this invention has been described in terms of the preferred embodiments thereof, it is not intended to be so limited, but rather only to the extent set forth in the claims that follow.

We claim:

1. A surround view monitoring system configured to synthesize a birds-eye-view image of an area around a vehicle, said system comprising:
a camera configured to capture a present-image of a field-of-view about the vehicle and output a signal indicative of the present-image, wherein the present-image includes a feature of the vehicle; and
a controller configured to receive the signal, compare the present-image to a reference-image from an initial calibration of the system, wherein the reference-image includes the feature, and determine a correction table for the present-image to align the feature in the present-image to the feature in the reference-image.

2. The system in accordance with claim 1, wherein the feature is an edge of the vehicle.

3. The system in accordance with claim 1, wherein the correction table includes a pan angle, a yaw angle, and a roll angle.

4. The system in accordance with claim 1, wherein the controller is configured to align the present-image on a periodic basis.

5. The system in accordance with claim 1, wherein the controller is configured to perform the initial calibration only when the vehicle is moving, and an ambient light intensity is greater than an illumination threshold.
